(19) United States
(12) Patent Application Publication
(10) Pub. No.: US 2019/0102955 A1
(43) Pub. Date: Apr. 4, 2019

(54) METHOD FOR AUTOMATICALLY EXPOSING A BRANCH-OFF POINT IN A LINE SYSTEM

(71) Applicant: PIPETRONICS GMBH & CO. KG, Rohrbach (DE)

(72) Inventors: Herbert Wind, Albersweiler (DE); Christian Noll, Limburgerhof (DE)

(21) Appl. No.: 16/086,546

(22) PCT Filed: Mar. 23, 2017
(86) PCT No.: PCT/DE2017/100235

§ 371 Date: Sep. 19, 2018

(30) Foreign Application Priority Data
Mar. 24, 2016 (DE) 10 2016 105 641.3

(51) Int. Cl. G06T 19/20; B29C 63/00; F16L 55/48; G06T 11/20; F16L 41/02

(52) U.S. Cl. CPC G06T 19/20; B29C 63/0013; B29C 2793/0018; G06T 11/20; F16L 41/02; F16L 55/48

(57) ABSTRACT

The present invention relates to a method for automatically uncovering a branch of a pipe system that is renovated with a lining tube, comprising the following steps, in particular in this sequence:
a) providing an uncovering device, including a data processing unit, in the renovated pipe and arranging the uncovering device in front of the branch to be uncovered;
b) inputting by means of an input unit a geometric shape to be uncovered;
c) uncovering the branch by means of automatic milling, controlled by the data processing unit, of sections of the lining tube along the input geometric shape, using an uncovering unit of the uncovering device.

The present invention relates to a method for automatically uncovering a branch in a pipe system.

For inspection, maintenance, and renovation of pipes, duct systems, and the like, devices are often inserted into the pipes in order to carry out the necessary measuring operations and/or mechanical renovation activities. For measuring the actual situation of a pipe, the devices usually have camera systems for visualizing the condition of the pipe.

If a defect or damage is recognized, the section of the pipe system in question may be replaced by new sections. However, this is generally very complicated.

Alternatively, methods are known in the prior art in which for renovating pipe systems, for example ducts and similar piping systems, a flexible, curable layer that is impregnated with a curable resin, used as a lining tube (also referred to as a liner), is inserted into the pipe system. After the insertion, the lining tube is expanded so that it lies tightly against the inner wall of the pipe system. The resin is subsequently cured.

The manufacture of this type of lining tube is described in WO 95/04646, for example. According to the known methods, preferably unsaturated polyester resins or vinyl ester resins, which can be dissolved in styrene and/or an acrylic ester, for example, are used as curable resins. These unsaturated polyesters or vinyl esters may be cured thermally (generally using peroxide catalysts) or by radiation, for example via UV light with photoinitiators, as described in EP-A 23623, for example. In addition, so-called combination curing, with a peroxide initiator that is used for the thermal curing in combination with photoinitiators, is possible, and has proven advantageous in particular for large wall thicknesses of the lining tubes. A method for such so-called combination curing is described in EP-A 1262708, for example.

A radiation-curing lining tube typically has an outer protective film that is impermeable to light, an inner film that is permeable at least to certain wavelength ranges of electromagnetic radiation, and a curable layer that is impregnated with a resin and situated between the inner film and the outer film. The outer film tube is intended to prevent the resin, used for the impregnation, from escaping from the curable layer and into the environment. This requires good seal-tightness and bonding of the outer film tube to the resin-impregnated, curable layer.

Prior to the curing, the lining tubes are inserted into the pipe system to be renovated, and inflated by means of a fluid, generally compressed air. For inflating the lining tube, according to the prior art an opening end of the lining tube is acted on by compressed air, and the opposite opening end of the lining tube is closed with a closure device, a so-called packer. This closure device includes a hollow cylinder and a cover element with which the hollow cylinder may be closed.

For curing the lining tube, a curing device is inserted therein, the curing device having a radiation source and being guided through the lining tube in order to activate or carry out the curing of the curable layers of the lining tube by means of the radiation energy. Complete curing of the lining tubes is of great importance; i.e., a specified quantity of radiation energy must be introduced into the lining tube at every point on the lining tube. The quantity of radiation energy is a function of the power output of the radiation sources, and of the speed with which it is passed through the lining tube.

When such lining tubes are drawn into the pipe to be renovated, it is necessary to once again uncover the branches, closed by the lining tube, after the lining tube has cured. For this purpose, the position of the branches must be known as accurately as possible.

For detecting pipes by measurement, and in particular for determining the position of branches, according to the prior art measuring devices are typically inserted into the pipe before the lining tube is drawn in, the measuring device being moved through a pipe to be renovated either automatically, or with the aid of a cable, in particular a cable that includes Kevlar fibers and/or at least one traction cable, and/or a traction cable.

The measuring device according to the prior art detects the position of the branches prior to drawing in the lining tube, typically via optical sensors, in particular camera recordings. In the following discussion, the term “branches” is understood in a broad sense, and includes side inlets, also referred to as pipe inlets or pipe branches. When a branch is recognized, either a speed sensor, which counts the number of revolutions of the wheels of the measuring device, which measures the length of the [omission in source text] for moving the cable or traction cable, or a measuring tape that is carried along by the curing device is used for determining the position of the branch in the pipe.

However, the position of the branch must be detected with regard not only to its distance from one or both opening ends of the pipe, but also in its angular position. Rotation angle sensors or gravity sensors, for example, are used for this purpose.

When the position of a branch is known, the branch must subsequently be uncovered by means of an uncovering device. This currently takes place manually, the manual method optionally being assisted by the use of distance sensors and the like. Several factors are problematic with the manual uncovering. On the one hand, controlling the uncovering devices is associated with a high level of training effort for the user. For an untrained user, it is practically impossible to produce a desired circular recess, for example. An uncovering device according to the prior art is typically a mobile device having a robot arm with a milling head arranged on its free end. To uncover the branch, it is necessary not only to control the milling head at the end of the robot arm in all three spatial directions, but, due to the size of the recesses to be produced, during the uncovering to also move the device itself back and forth in front of the branch to be uncovered. This coordination of the robot arm and the position of the milling head is a very complicated manual operation.

On the other hand, the uncovering is also complicated by the fact that, for a pipe that is renovated with a lining tube, the user must always uncover a branch that is concealed by the lining tube, and therefore not visible to the user. In addition, the uncovering is made even more difficult by the fact that the camera systems for displaying the working area of the milling head are generally mounted on the side of the uncovering device, so that a distortion of perspective is always present. Uncovering a circular branch, for example, is thus additionally hampered, since the stated distortion of perspective must be intuitively corrected by the user.

Even more complex is the uncovering of obliquely extending inlet pipes.

Branches of pipe systems are not exclusively right-angled, and are also angled, for example at an angle of 45°. In this case an ellipsoidal cutout of the lining tube must be made in order to uncover this type of branch. Producing such an elliptical recess freehand in order to intuitively compensate for the distortion of perspective of the camera systems, and controlling a milling head in three spatial directions in parallel to the positions of the uncovering device as such, is very difficult to do precisely, even for experienced users.

Thus, in the known methods and devices it is disadvantageous that uncovering a branch is very susceptible to manual operating errors. Imprecise uncovering of the branch may very easily result in damage to same, in that the milling head often used for uncovering causes damage to the wall of the branch, thus requiring time-consuming, costly repairs. A second problem is that the branch may possibly not be uncovered over its full circumference, so that, in particular in the event of incomplete uncovering in the lower area, blockages and accumulations of or by liquids may occur. This is likewise undesirable.

The object of the present invention, therefore, is to overcome the disadvantages of the prior art, and in particular to allow a user to precisely uncover branches in pipes that are renovated with lining tubes.

This object is achieved by a method for automatically uncovering a branch of a pipe system that is renovated with a lining tube, comprising the following steps, in particular in this sequence:
a) providing an uncovering device, including a data processing unit, in the renovated pipe and arranging the uncovering device in front of the branch to be uncovered;
b) inputting by means of an input unit a geometric shape to be uncovered;
c) uncovering the branch by means of automatic milling, controlled by the data processing unit, of sections of the lining tube along the input geometric shape, using an uncovering unit of the uncovering device.

As the result of a method according to the invention, it is possible for a user to input as desired a geometric shape to be uncovered, and subsequently to automatically traverse the input geometric shape by means of the uncovering unit of the uncovering device, thus creating an opening in the lining tube corresponding to the stated shape. The problems that occur in the prior art involving the complex manual control of the uncovering device, the difficult compensation for the distortion of perspective, and the difficulties in manually producing complex uncovered areas are thus overcome according to the invention.

According to the invention, a geometric shape is understood to mean any given geometric shape, for example a simple straight line, a curve, and the like. Of course, a geometric shape is not limited in its complexity, and may also be present in the form of a circle, an ellipse, a rectangle, an n-gon, or other complex shapes that include straight and curved sections.

According to one embodiment, it may be preferred that the geometric shape is specified by its outer boundaries, and in particular forms a closed geometric shape to allow an opening to be produced directly in the lining tube. Alternatively, it may be provided that the geometric shape is open, and sections to be uncovered that are not included by the geometric shape are manually uncovered.

The method according to the invention thus allows, in a novel manner, automatic uncovering of a branch in a pipe that is renovated with a lining tube.

According to one embodiment of the present invention, it may be preferred that the method further comprises the following steps, in particular in parallel or subsequent to step b):
d) inputting the geometric shape by selecting the geometric shape from a shape library of geometric figures stored in the data processing unit, in particular including circles, ellipses, rectangles, and/or polygons, or
e) drawing the geometric shape freehand and reading the stated shape into the data processing unit by means of an image detection unit, in particular a scanner or a camera device, or
f) drawing the geometric shape freehand by means of the input unit, in particular by means of a Trackpack or a mouse, wherein in particular at least one of the parameters is selected or selectable from a group of parameters including a length, a width, a height, and a diameter of the geometric shape.

According to the invention, a geometric shape may be input or selected in various ways. It has proven advantageous when a shape library of common geometric shapes such as circles, ellipses, etc., is already stored in a database of the data processing unit. Frequently encountered geometries of sections of the lining tube to be uncovered may be selected by use of such a shape library, using simple means. It may also be provided that before the lining tube is drawn into the pipe to be renovated, the geometry of the branch subsequently concealed by the lining tube may be detected by measurement by means of a measuring device, and an in particular precisely detected geometry of the stated branch in the data processing unit is incorporated into the shape library for a subsequent selection.

Alternatively, it may be provided that a user sketches a desired shape on a piece of paper, for example, and then photographs, scans, or otherwise digitizes it; this shape that is drawn freehand may then be used for the subsequent automatic uncovering.

It may also be preferred that the selected geometric shape may be withdrawn from the shape library or the digitized drawn geometric shape by “drag and drop” onto a camera recording, displayed on a display device, of the uncovering device for the section of the lining tube to be uncovered, and in particular may subsequently be positioned there at the desired location.

Alternatively, it may also be provided that the user draws the desired geometric shape directly by means of an input unit such as a mouse or a Trackpad. It may be advantageous in particular when such drawing takes place directly on a camera recording, displayed on a display device, of the uncovering device for the section of the lining tube to be uncovered, so that the user, similarly as for an “augmented reality” approach, may intuitively determine the subsequent automated uncovering.

In all three variants, it is advantageous when, after the geometric shape is specified, its width, length, diameter, etc., may be refined by inputting appropriate parameters.

It may also be preferred that the method according to the invention further comprises the following steps, in particular in parallel or subsequent to step b):
g) inputting a position of the geometric shape relative to the inner wall of the lining tube by means of the input unit, in particular an angular position of the geometric shape based on a midpoint of the radius of the lining tube and/or a distance based on the deepest point of the lining tube, and/or
h) detecting the position of the free end of the uncovering unit and automatically arranging the geometric shape, beginning at the detected position of the free end of the uncovering unit, and
i) subsequently optionally turning, rotating, tilting, and/or displacing the geometric shape by means of the input unit.

To allow the most intuitive determination possible of the section to be uncovered, it may be advantageous that the position of the geometric shape may be provided by inputting parameters. This may also take place by “drag and drop.” It may be provided that a camera recording of the section of the lining tube to be uncovered is displayed to the user on a display unit, and is superimposed on the geometric shape, wherein additional information such as distances of the geometric shape from the base area of the lining tube, for example, angular positions, etc., may additionally be displayed. So-called positioning aids may also be used, in which the geometric shape according to the invention is optionally “stuck” directly on the inner wall of the lining tube and lies against same, without the user having to make a corresponding input. This additionally simplifies the positioning of the geometric shape.

It may also be provided that the geometric position is automatically situated at the detected position of the milling head of the uncovering unit. This is advantageous in particular when the milling head is initially manually moved by a user to the desired position, and the automated uncovering is to subsequently take place. In this case, the data to be input for positioning the geometric shape are further minimized, since a corner point of the positioning is specified by the position of the uncovering device.

Furthermore, it may be provided that the uncovering device is designed in the form of a mobile robot having a chassis, and in particular includes a drive unit and/or is movable by means of a cable, in particular a cable that includes Kevlar fibers and/or at least one traction cable, and/or a traction cable, and a drive unit that is externally connected to the cable and/or the traction cable.

According to one embodiment of the method according to the invention, it may also be advantageous that the data processing unit is designed and configured for controlling or regulating the position of the uncovering device in the lining tube, in particular also during the uncovering of the branch.

It may also be preferred that the uncovering unit of the uncovering device is situated on a movable end of a robot arm that is movable in at least two, in particular three, spatial axes, and that is in particular retractable and/or includes at least one telescoping arm element.

According to the invention, it has proven advantageous when the uncovering device is designed in the form of an uncovering robot. The uncovering robot may then be automatically positioned by means of the data processing unit in order to carry out the intended automatic uncovering of the geometric shape. For this purpose, it may also be advantageous in particular when the uncovering device includes a movable robot arm with the milling head arranged on its free end.

It may also be provided that the method according to the invention further comprises the following steps, in particular before step b):
j) manually or automatically uncovering a segment of the branch that is in particular spaced apart from the edge of the branch, preferably in the area of the midpoint of the branch, by means of an uncovering unit; and
k) manually or automatically uncovering an elongated segment, beginning from the first uncovered segment in the direction of an inner wall of the branch, in particular directed downwardly.

It may be prove to be advantageous that initially a first section of the branch is manually uncovered. It may be provided in particular that a first recess is spaced apart from the assumed inner wall of the branch, preferably in the area of the middle of the inner wall. Starting from this first recess, the uncovering unit may subsequently be manually moved to the edge of the branch. When this edge is reached, the automated uncovering may then be started.

It may also be advantageous that the method according to the invention further comprises the following steps, in particular before step a):
l) detecting a position of a branch, in particular by means of a measuring device, before a lining tube is drawn into the pipe to be renovated, and storing the position in the data processing unit, or
m) inputting the position of a branch in the data processing unit, and
n) subsequently manually or automatically moving the uncovering device to the position of the branch that is stored in the data processing unit.

According to one embodiment of the present invention, it may be advantageous that a detection of the position and the geometry of the branch to be uncovered initially takes place by means of a measuring device. This is particularly advantageous, since the drawn-in position of the branch does not have to exactly match the position that is actually present. In addition, the outer shape of the branch may deviate from the known shape due to cracks and spalling. According to the invention, a three-dimensional detection of the branch, and optionally of the edge region of the branch, may preferably take place in order to store in the data processing unit the position and shape of the dimensions to be uncovered for the necessary uncovering of the lining tube after it is drawn out.

Alternatively, according to one embodiment of the present invention it may be advantageous for the position of the branch to be input.

Furthermore, it may be preferred that the automated uncovering takes place in sections, and the length of the sections is settable by the user, preferably in the form of circular segment-shaped sections, wherein in particular after each of the sections, manual uncovering of the subsequent section takes place.

Such uncovering of the branch in sections has the advantage that after specific sections, a check of the uncovering operation may be made in which the automated uncovering does not take place continuously.

Lastly, it may be provided that the automated uncovering may be superimposed by manual inputting by the user for controlling the uncovering device by means of the input unit, so that manual uncovering takes place in sections, wherein after the manual intervention ends, the uncovering is automatically continued along the specified geometric shape.

Such superimposed manual uncovering may result in simple correction of the uncovering operation if the user considers this to be necessary.

Further features and advantages of the invention result from the following description, in which one exemplary embodiment of the invention is explained by way of example with reference to one schematic drawing, without thereby limiting the invention.

In the figure:

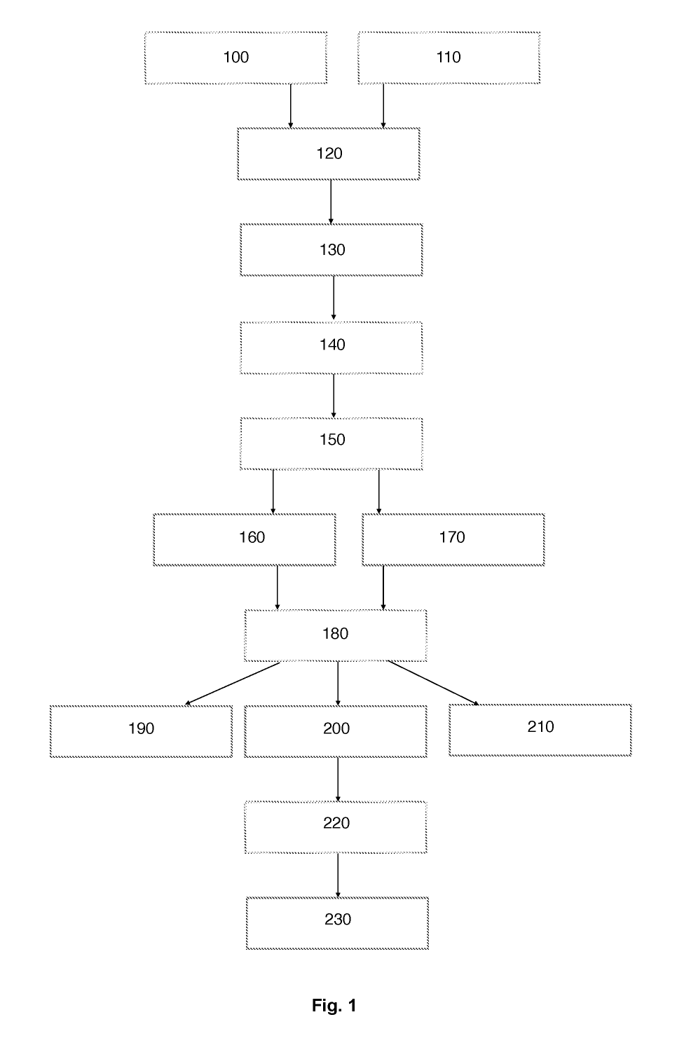

FIG. 1: shows a schematic flow chart of one exemplary embodiment of a method according to the invention.

One embodiment of a method according to the invention is described below. In a first optional method step 100, a position of a branch may initially be detected before a lining tube is drawn into the pipe to be renovated, wherein the detected position is detected in particular by means of a measuring device and subsequently stored in a data processing unit. Alternatively, the position of the branch may be input into the data processing unit by the user.

In the next method step 120, an uncovering device is provided, and in a method step 130 the uncovering device is subsequently manually or automatically moved to the position of the branch that is stored in the data processing unit.

In a method step 140, manual or automatic uncovering of a segment of the branch, in particular spaced apart from the edge of the branch, preferably in the area of the midpoint of the branch, may now take place, once again optionally, by means of an uncovering unit of the uncovering device. This may optionally be followed by manual or automatic uncovering of an elongated section, beginning from the first uncovered segment in the direction of an inner wall of the branch, in particular directed downwardly (see method step 150).

In a step 160, a position of a geometric shape relative to the inner wall of the lining tube is now input by means of an input unit, or in a method step 170 the position of the free end of the uncovering unit is detected and the geometric shape is arranged, beginning at the detected position of the free end of the uncovering device. Turning, rotating, tilting, and/or displacing the geometric shape by means of the input unit then optionally take(s) place in a method step 180.

Before or after steps 160 through 180, in a step 190 either the geometric shape to be uncovered is input by selecting the geometric shape from a shape library of geometric figures stored in the data processing unit, or in a method step 200 the geometric shape is drawn freehand and the stated shape is read into the data processing unit by means of an image detection unit, or in a method step 210 the geometric shape is drawn freehand by means of the input unit, in particular by means of a Trackpack or a mouse, in each case followed by an optional selection of at least one parameter of the geometric shape, such as a length, a width, a height, and a diameter of the geometric shape, in step 220.

Lastly, uncovering of the branch by means of automatic milling of sections of the lining tube, controlled by the data processing unit, along the input geometric shape is carried out with an uncovering unit of the uncovering device in a method step 230.

The features of the invention disclosed in the preceding description and in the claims may be important, alone or also in any given combination, for implementing the invention in its various embodiments.

1. A method for automatically uncovering a branch of a pipe system that is renovated with a lining tube, comprising the following steps, in particular in this sequence:
a) providing an uncovering device, including a data processing unit, in the renovated pipe and arranging the uncovering device in front of the branch to be uncovered;
b) inputting by means of an input unit a geometric shape to be uncovered;
c) uncovering the branch by means of automatic milling, controlled by the data processing unit, of sections of the lining tube along the input geometric shape, using an uncovering unit of the uncovering device.

2. The method according to claim 1, further comprising the following steps, in particular in parallel or subsequent to step b):
d) inputting the geometric shape by selecting the geometric shape from a shape library of geometric figures stored in the data processing unit, in particular including circles, ellipses, rectangles, and/or polygons, or
e) drawing the geometric shape freehand and reading the stated shape into the data processing unit by means of an image detection unit, in particular a scanner or a camera device, or
f) drawing the geometric shape freehand by means of the input unit, in particular by means of a Trackpack or a mouse, wherein
in particular at least one of the parameters is selected or selectable from a group of parameters including a length, a width, a height, and a diameter of the geometric shape.

3. The method according to claim 1, further comprising the following steps, in particular in parallel or subsequent to step b):
g) inputting a position of the geometric shape relative to the inner wall of the lining tube by means of the input unit, in particular an angular position of the geometric shape based on a midpoint of the radius of the lining tube and/or a distance based on the deepest point of the lining tube, and/or
h) detecting the position of the free end of the uncovering unit and automatically arranging the geometric shape, beginning at the detected position of the free end of the uncovering unit, and
i) subsequently optionally turning, rotating, tilting, and/or displacing the geometric shape by means of the input unit.

4. The method according to claim 1, characterized in that the uncovering device is designed in the form of a mobile robot having a chassis, and in particular includes a drive unit and/or is movable by means of a cable, in particular a cable that includes Kevlar fibers and/or at least one traction cable, and/or a traction cable, and a drive unit that is externally connected to the cable and/or the traction cable.

5. The method according to claim 4, characterized in that the data processing unit is designed and configured for controlling or regulating the position of the uncovering device in the lining tube, in particular also during the uncovering of the branch.

6. The method according to claim 1, characterized in that the uncovering unit of the uncovering device is situated on a movable end of a robot arm that is movable in at least two, in particular three, spatial axes, and that is in particular retractable and/or includes at least one telescoping arm element.

7. The method according to claim 1, further comprising the following steps, in particular before step b):
j) manually or automatically uncovering a segment of the branch that is in particular spaced apart from the edge of the branch, preferably in the area of the midpoint of the branch, by means of an uncovering unit; and
k) manually or automatically uncovering an elongated segment, beginning from the first uncovered segment in the direction of an inner wall of the branch, in particular directed downwardly.

8. The method according to claim 1, further comprising the following steps, in particular before step a):
l) detecting a position of a branch, in particular by means of a measuring device, before a lining tube is drawn into the pipe to be renovated, and storing the position in the data processing unit, or
m) inputting the position of a branch in the data processing unit, and
n) subsequently manually or automatically moving the uncovering device to the position of the branch that is stored in the data processing unit.

9. The method according to claim 1, characterized in that the automated uncovering takes place in sections, and the length of the sections is settable by the user, preferably in the form of circular segment-shaped sections, wherein in particular after each of the sections, manual uncovering of the subsequent section takes place.

10. The method according to claim 1, characterized in that the automated uncovering may be superimposed by manual inputting by the user for controlling the uncovering device by means of the input unit, so that manual uncovering takes place in sections, wherein after the manual intervention ends, the uncovering is automatically continued along the specified geometric shape.
